(19) United States
(12) Patent Application Publication
(10) Pub. No.: US 2015/0081380 A1
(43) Pub. Date: Mar. 19, 2015

(54) COMPLEMENT SELF SERVICE BUSINESS INTELLIGENCE WITH CLEANSED AND ENRICHED CUSTOMER DATA

(71) Applicants: Ronen Cohen, Gesher Haziv (IL); Emmanuel Zarpas, Paris (FR)

(72) Inventors: Ronen Cohen, Gesher Haziv (IL); Emmanuel Zarpas, Paris (FR)

(21) Appl. No.: 14/029,503

(22) Filed: Sep. 17, 2013

(51) Int. Cl. G06Q 30/02

(52) U.S. Cl. CPC G06Q 30/0201
USPC 705/7.29

(57) ABSTRACT

According to some embodiments, a method of self-service business intelligence and an apparatus are provided to receive a first plurality of data records at a client device executing a self-service business intelligence application. A request to a master data service to lookup the first plurality of data records is sent via an intermediary database. A second plurality of data records comprising a cleansed and consolidated version of the first plurality of data records is received.

### BACKGROUND

Data scientists typically like to incorporate cleansed and enriched customer data in a data analysis session to base their analysis on quality master data and, as a result, increase their chances to arrive at more valid and reliable business decisions, which may hopefully increase their business competiveness. Incorporating cleansed and enriched customer data in a data analysis session is currently carried out with assistance from an information technology (“IT”) department.

Presently, most self-service business intelligence (“BI”) tools don't incorporate quality customer data, and the information they infer from analysis is not reliable. For example, a single customer can appear in different systems with different names or addresses and as such decisions regarding marketing to and retention of this customer can be biased and lead to un-optimized business decisions and loss of opportunities.

### BRIEF DESCRIPTION OF THE DRAWINGS

FIG. 1 illustrates a method according to some embodiments.

FIG. 2 illustrates a system according to some embodiments.

FIG. 3 illustrates a portion of a data file according to some embodiments.

FIG. 4 illustrates a portion of a data file according to some embodiments.

FIG. 5 illustrates a portion of a data file according to some embodiments.

FIG. 6 illustrates a portion of a data file according to some embodiments.

FIG. 7 illustrates a performance graph according to some embodiments.

FIG. 8 illustrates a performance graph according to some embodiments.

FIG. 9 illustrates an apparatus according to some embodiments.

### DETAILED DESCRIPTION

The present embodiments relate to a system and method of self-service business intelligence to incorporate cleansed and enriched customer data directly into a data file that a business user or data scientist is about to analyze, in a self-service manner without needing assistance an IT department. The present embodiments further relate to the use of Master Data Services (“MDS”), such as, but not limited to SAP MDS. MDS comprises a database system that consolidates data from a plurality of data sources, and stores the data in one central and authoritative database. As part of the consolidation process, and in the case of multiple different representations for the same real world entity, MDS comprise a best record representation of the entity based on a set of survivorship rules. The best records may be referenced from different applications in a typical data oriented task. Moreover, the set of best records may be referenced in a real time manner, inside the consuming application context, and may include such usage from a self-service BI application.

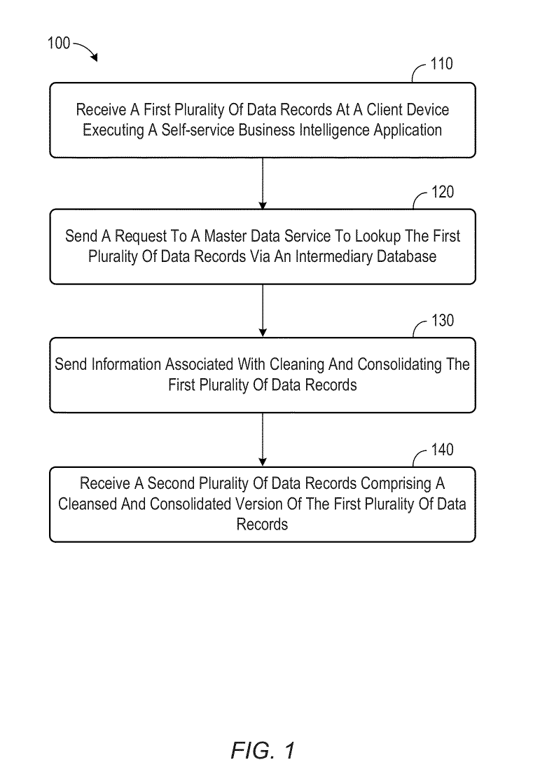

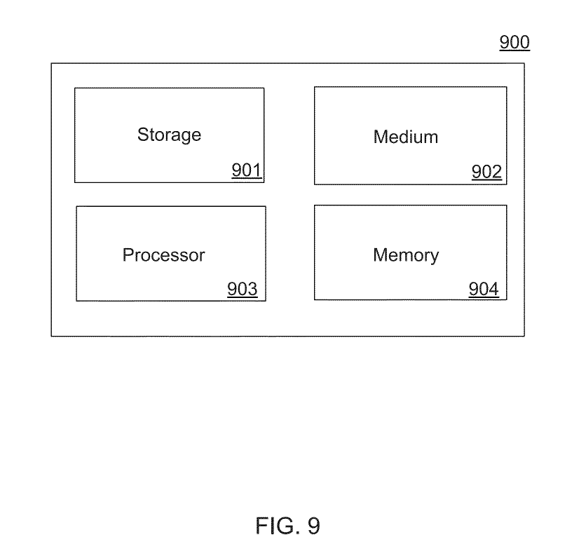

Referring now to FIG. 1, an embodiment of a method 100 is illustrated. The method 100 may be embodied on a non-transitory computer-readable medium. Furthermore, the method 100 may be performed by an apparatus such as, but not limited to, the apparatus of FIG. 9 in substantially real time.

At 110, a first plurality of data records is received at a client device. The first plurality of data records comprise local data and may be received at a local computing device running a self-service BI software application. As used herein, the phrase “BI software application” may refer to for example, SAP Lumira. In some embodiments, each record of the first plurality of data records comprises at least one identifying attribute such as, but not limited to, a source key, social security number (“SSN”) or email address.

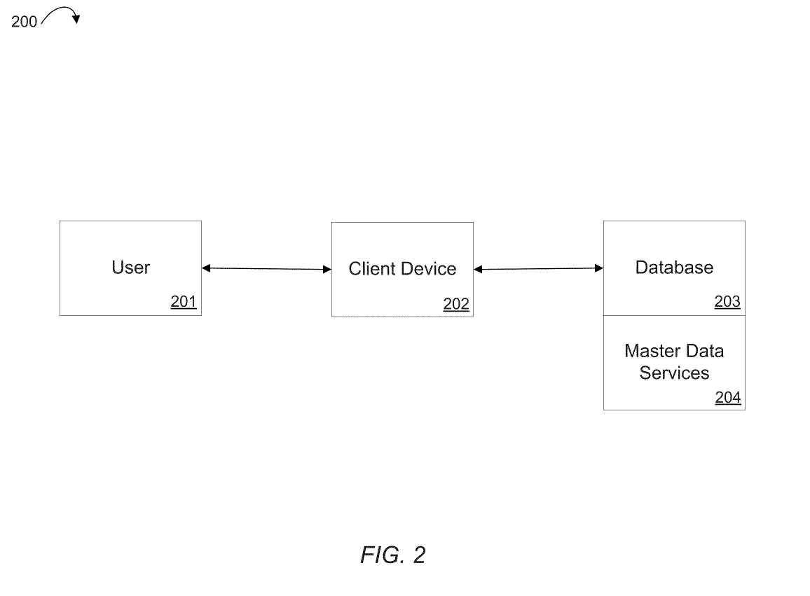

For illustrative purposes, and to aid in understanding features of the specification, an example will be introduced. This example is not intended to limit the scope of the claims. Now referring to FIG. 2, a system comprising a user 201, a client device 202, a database 203 and a MDS 204 are illustrated. The client device 202 may comprise a laptop computer, a desktop computer, or a mobile device, such as, but not limited to a tablet or a smart phone. The database 203 may comprise an in-memory column based database, such as, but not limited to SAP HANA. The database 203 may comprise a database management system that primarily relies on main memory for computer data storage instead of a disk storage mechanism. Accessing data from an in-memory database is faster and more predictable than a disk based database management system. The database 203 may interface with the MDS 204 database.

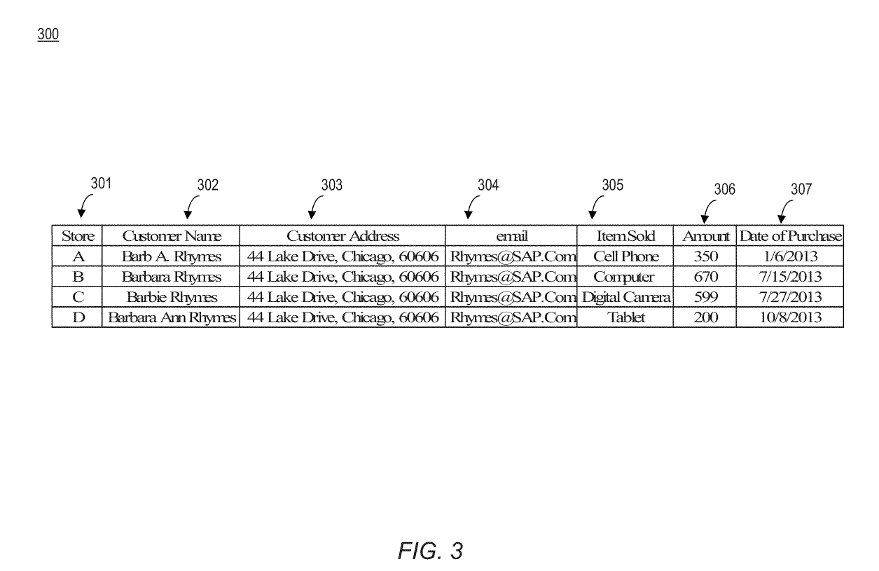

In the present example, the user 201 may wish to perform analysis on a local data file such as data file 300 of FIG. 3. As illustrated, the local data file 300 comprises a plurality of data records. The user 201 may load or access this data file 300 via the client device 202 which comprises local self-service BI software such as, but not limited to, SAP Lumira.

As illustrated in FIG. 3, the local data file 300 may comprise customer data that includes multiple records associated with a same real world person. In the present example, the local data file 300 comprises information such as a store 301 where the person shopped, the person's name 302, the person's address 303, the person's email 304, an item sold to the person 305, an amount of the purchase 306 and a date of purchase 307. In the present embodiment, the person may be identified by their email 304. Even though the name 302 varies in each of the records, the local data file 300 illustrates that the plurality of data records in the local data file 300 may comprise two or more records associated with a same person.

Next, at 120 a request to lookup the first plurality of data records is sent. The request may be sent to a MDS. The request may be a straightforward request that attempts to match the plurality of data records based on identifying attributes like: source key, SSN, email, and the like against the MDS' databases, and retrieve to the self-service BI session the corresponding best records. According to some embodiments, the request may be a fuzzy match request that tries to match the first plurality of data records based on non-identifying attributes like name and address. The request comprises input parameters such as, but not limited to, a selected dataset to be matched, a predefined matching strategy which may include typical matching parameters (e.g. which attributes to match), low and high matching thresholds, and/or a target MDS database to be matched against.

Continuing with the above example, in a first embodiment, MDS 204 may create a best records view in the database 203 which may be consumed by the local self-service BI software at the client device 202. The best records view may comprise data associated with the local data file 300 (e.g., the first plurality of data records). Furthermore, the best records views may be retrieved directly from the MDS 204 via the database 203 which may then load the best records views as views associated with the database 203. The best records view may then be accessed/consumed by the local self-Service BI software. The self-service BI software may compare the local data file 300 to be analyzed with the MDS 204/database 203 views using exact key matching, and may merge the matched records into the local data file 300 using an outer join operation, assuming that a unique customer identifier exists in the customer sales data.

Furthermore, additional attributes from MDS views may be appended to the local data file 300 in order to enrich the local data file 300 if the additional attributes are available.

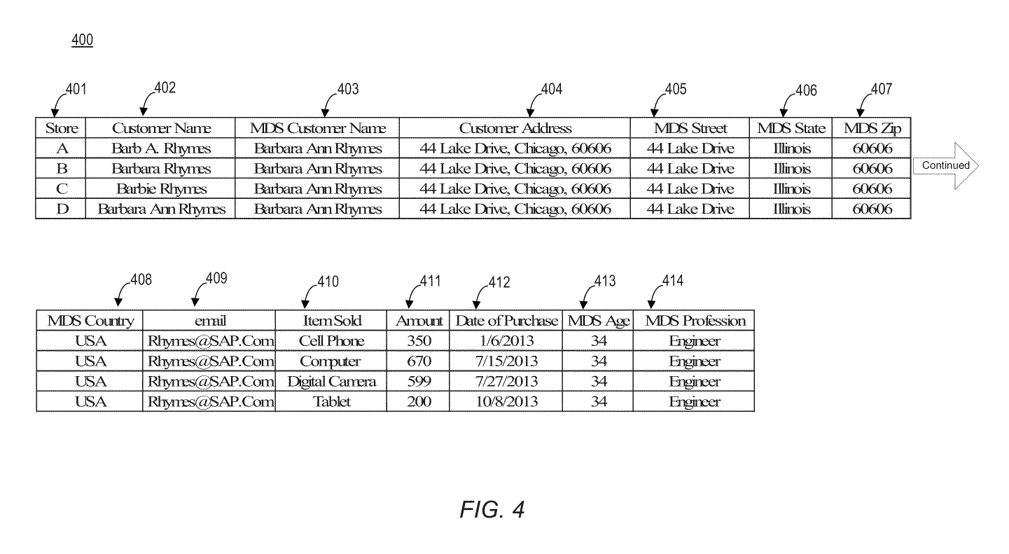

In practice, a user may connect the local data file 300 on his client device 202 to a MDS best record view, and lookup a source key, SSN, email or other unique identifier against the MDS database view which comprises cleansed & enriched customer data. If there is a match, the user may activate a merge button on the self-service BI software side, causing the client device to create a combined dataset. Additional attributes that originate from MDS 204 may be prefixed with “MDS” or any other indictor to illustrate that the data comes from MDS 204. For example, and referring to FIG. 4, a portion of a data file 400 is illustrated. In this example, a customer may have wanted to analyze his local data (e.g., local data file 300) based on a store identification 401, customer name 402, customer address 404, item sold 410, amount of sale 411 and a date of purchase 412.

In this example, two functions may have been performed on the local data. The first is that the local file data was cleansed based on the MDS 204. This is evidenced by the MDS 204 correcting the name (e.g., MDS customer name 403) and tokenizing the customer address 404 (e.g., a MDS street 405, MDS state 406, MDS zip 407, and MDS country 408). The MDS prefix may have been added as an indicator to illustrate that the data came from the MDS 204.

The second function performed may have been that additional customer attributes that were stored in MDS 204, which may have originated from external data providers, were attached to the data file 400. This is evidenced by the fields MDS age 413, and MDS profession 414.

However, in many circumstances, a unique customer identifier may not be available and MDS 204 may match customer data against the MDS database using fuzzy match capabilities on attributes like a customer name and address in order to increase a likelihood of matching. In some embodiments, the local self-service BI software may treat MDS 204 as a reference provider. By using MDS 204 as a reference provider, instead of simply joining a view created by the MDS 204 to the local data file 300, a data scientist/business user may look up the local data file 300 against the MDS 204 and in return get back matching records and additional relevant attributes, based on a configuration that specifies types of information to retrieve from the MDS 204.

At 130, information associated with cleaning and consolidating the first plurality of data records is sent. For example, in this embodiment, the local self-service BI software may send a request to match a single record or batch of records. In response to the request, MDS 204 may first standardize the data (e.g., address and names fields) and then try to match the data against its own database. In the case that more than a single match was found, e.g. a single source record was matched to multiple MDS records, the MDS might return a single record based on the latest timestamp.

In practice, the client device 202 may initially call a matching service located within the MDS 204 via the database 203 to resolve the identity of customer records within the local data file 300 that the business user is going to analyze, and immediately after, try to match the local data file 300 against the MDS database system.

The business user may select a set of customer records, and relevant customer attributes for matching. While selecting the attributes for matching, the user may classify each attribute to a predefined type. For example, the customer name 302 may be classified as a name type field, the email address 304 may be classified as an email type field and the customer address 303 may be classified as an address type field. Classifying field types may help to automatically map customer data to predefined types expected by a matching algorithm.

The local self-service BI software may send a request to an Application Programming Interface (“API”) to match a single record or multiple records against the MDS database. In some embodiments, the MDS 204 may first cleanse and standardize the data based on, for example, address and name attributes. Immediately after, the database 203 may attempt to match the cleansed records against the MDS database.

If a duplicate detection (e.g., matching) function is invoked without indicating a MDS database to match the local data file 300 against, the MDS may detect duplicates within the selected dataset (i.e., the local data file itself). On the other hand, if the parameter is not empty, the MDS 204 may match the dataset against a MDS database. In a case where more than a single match is found, e.g. a single source record is matched to multiple MDS records, the database 203 may return a single record having the latest timestamp.

Referring back to FIG. 1, at 140, a second plurality of data records comprising a cleansed and consolidated version of the first plurality of data records is received at the client device 202. Continuing with the above examples, the local data file 300 may be cleansed and enriched.

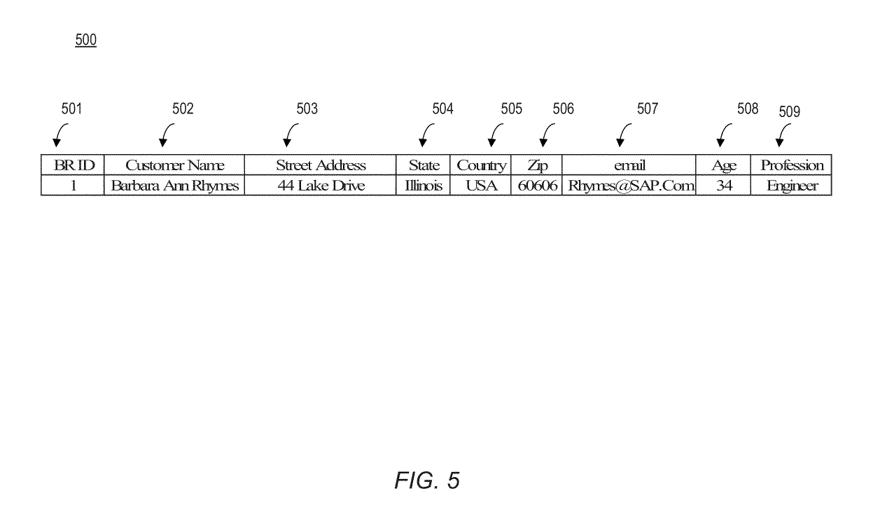

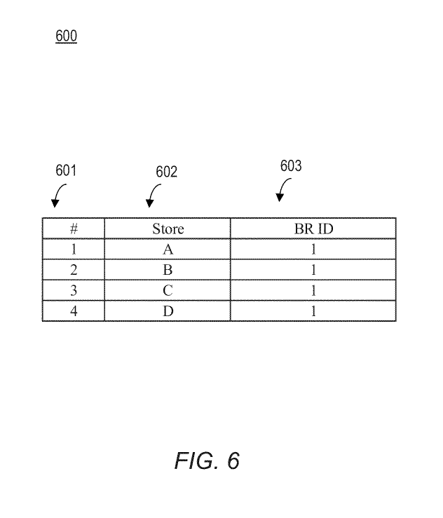

Now referring to FIG. 5 and FIG. 6, table 500 illustrates the results of an MDS consolidation process (e.g., cleansing, consolidating and enriching) based on the local data file 300. FIG. 5 illustrates an example of merging a set of four apparently related records into a single best record representation along with a cross reference table 600 that links each source record to its best record representation in the consolidated table 500.

A single best record representation, as illustrated in FIG. 5, discloses a business record identifier 501, customer name 502, street address 503, state 504, country 505, zip code 506, email 507, age 508, and profession 509. The business record identification 501 links the best record representation to the cross reference table 600. The cross reference table 600, which is created as part of the cleansing and consolidating process, comprises fields for row number 601, store 602, and business record identifier 603. The cross reference table 600 may cross reference the original records from the local data file 300 to the single best representation in the consolidated table 500.

As can be seen in FIG. 5, the single best representation comprises better quality data than the local data file 300. For example, the name has been standardized as well as the address which was also tokenized to individual address elements. In addition, some external attributes which arrived from external data providers outside of the organization were appended and can be used in an analysis. For example, the age 508 and profession 509 elements were not present in the local data file 300. These are examples of data enrichment. Therefore the local data file 300, after being enriched, may include data elements not originally found in the local data file 300.The age 508 and profession 509 elements may have been retrieved from a secondary data source that provided the information to the MDS 204 or from records already stored within the MDS 204.

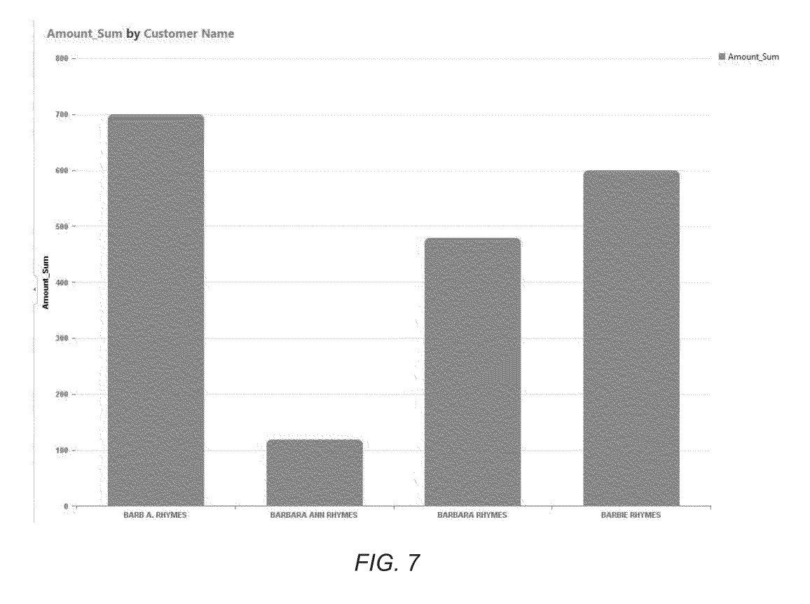

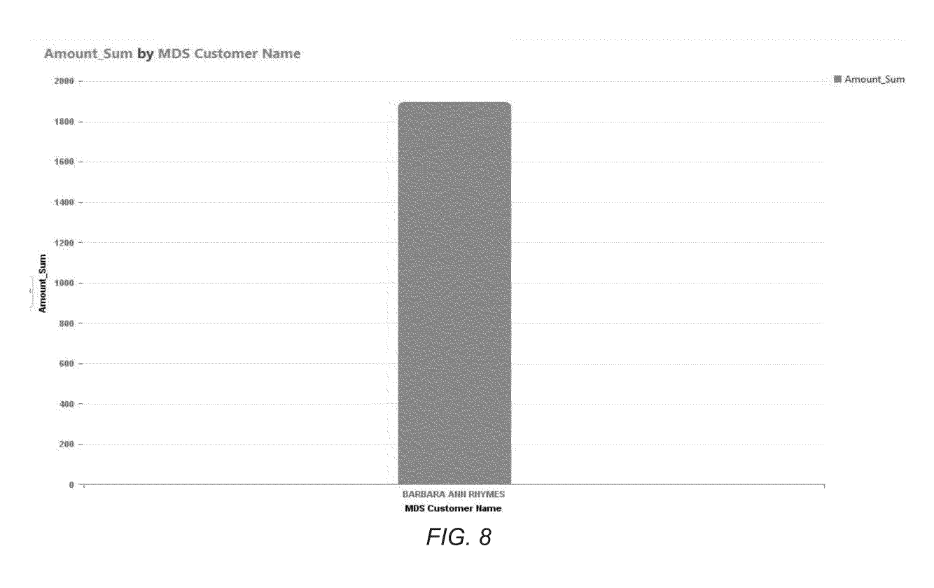

An impact of cleansing and consolidating a local data file based on quality master data from an MDS is illustrated at FIG. 7 and FIG. 8. FIG. 7 illustrates the four iterations of Barbara Rhymes that were found in the local data file 300. As can be seen, each iteration may be treated as an individual and thus a business analysis based on total sales (“Amount_Sum”) may be incorrect. However, after cleansing the data based on the MDS data, as seen in FIG. 8, a total sales amount for Barbara Rhymes was increased significantly and the business analysis may now be based on correct information.

Now referring to FIG. 9, an embodiment of an apparatus 900 is illustrated. In some embodiments, the apparatus 900 may be associated with a client device that executes a self-service BI software application. In one embodiment, the apparatus 900 may receive local data file 300.

The apparatus 900 may comprise a storage device 901, a medium 902, a processor 903, and memory 904. According to some embodiments, the apparatus 900 may further comprise a digital display port, such as a port adapted to be coupled to a digital computer monitor, television, portable display screen, or the like.

The medium 902 may comprise any computer-readable medium that may store processor-executable instructions to be executed by the processor 903. For example, the medium 902 may comprise a non-transitory tangible medium such as, but not limited to, a compact disk, a digital video disk, flash memory, optical storage, random access memory, read only memory, or magnetic media.

A program may be stored on the medium 902 in a compressed, uncompiled and/or encrypted format. The program may furthermore include other program elements, such as an operating system, a database management system, and/or device drivers used by the processor 903 to interface with peripheral devices.

The processor 903 may include or otherwise be associated with dedicated registers, stacks, queues, etc. that are used to execute program code and/or one or more of these elements may be shared there between. In some embodiments, the processor 903 may comprise an integrated circuit. In some embodiments, the processor 903 may comprise circuitry to perform a method such as, but not limited to, the method described with respect to FIG. 1.

The processor 903 communicates with the storage device 901. The storage device 901 may comprise any appropriate information storage device, including combinations of magnetic storage devices (e.g., a hard disk drive), optical storage devices, flash drives, and/or semiconductor memory devices. The storage device 901 stores a program for controlling the processor 903. The processor 903 performs instructions of the program, and thereby operates in accordance with any of the embodiments described herein.

The main memory 904 may comprise any type of memory for storing data, such as, but not limited to, a flash driver, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 904 may comprise a plurality of memory modules.

As used herein, information may be “received” by or “transmitted” to, for example: (i) the apparatus 900 from another device; or (ii) a software application or module within the apparatus 900 from another software application, module, or any other source.

In some embodiments, the storage device 901 stores a database (e.g., including information associated with customer data). Note that the databases described herein are only an example, and additional and/or different information may be stored therein. Moreover, various databases might be split or combined in accordance with any of the embodiments described herein.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method of self-service business intelligence comprising:
receiving a first plurality of data records at a client device executing a self-service business intelligence application;
sending, via a processor at the client device, a request to a master data service to lookup the first plurality of data records via an intermediary database; and
receiving, via the processor, a second plurality of data records comprising a cleansed and consolidated version of the first plurality of data records.

2. The method of claim 1, wherein the first plurality of data records comprises two or more non-duplicate records associated a same entity.

3. The method of claim 1, further comprising:
enriching the first plurality of data records and wherein the second plurality of data records comprise data elements not found in the first plurality of data records.

4. The method of claim 1, further comprising:
joining the first plurality of data records to a view from a master data database to clean and consolidate the first plurality of data records.

5. The method of claim 1, further comprising:
sending, via the processor, information associated with cleaning and consolidating the first plurality of data records, wherein the information associated with cleaning and consolidating the first plurality of data records is sent to the master data service.

6. The method of claim 5, wherein the information comprises a selected dataset to be matched, a matching strategy, and a target database.

7. A non-transitory computer-readable medium comprising instructions that when executed by a processor perform a method of self-service business intelligence, the method comprising:
receiving a first plurality of data records at a client device executing a self-service business intelligence application;
sending, via a processor at the client device, a request to a master data service to lookup the first plurality of data records via an intermediary database; and
receiving, via the processor, a second plurality of data records comprising a cleansed and consolidated version of the first plurality of data records.

8. The medium of claim 7, wherein the first plurality of data records comprises two or more non-duplicate records associated a same entity.

9. The medium of claim 7, wherein the method further comprises:
enriching the first plurality of data records and wherein the second plurality of data records comprise data elements not found in the first plurality of data records.

10. The medium of claim 7, further comprising:
joining the first plurality of data records to a view from a master data database to clean and consolidate the first plurality of data records.

11. The medium of claim 7, wherein the method further comprises:
sending, via the processor, information associated with cleaning and consolidating the first plurality of data records, wherein the information associated with cleaning and consolidating the first plurality of data records is sent to the master data service.

12. The medium of claim 11, wherein the information comprises a selected dataset to be matched, a matching strategy, and a target database.

13. An apparatus comprising:
a processor; and
a non-transitory computer-readable medium comprising instructions that when executed by a processor perform a method of self-service business intelligence, the method comprising:
receiving a first plurality of data records at a client device executing a self-service business intelligence application;
sending, via the processor, a request to a master data service to lookup the first plurality of data records via an intermediary database; and
receiving, via the processor, a second plurality of data records comprising a cleansed and consolidated version of the first plurality of data records.

14. The apparatus of claim 13, wherein the first plurality of data records comprises two or more non-duplicate records associated a same entity.

15. The apparatus of claim 13, wherein the method further comprises:
enriching the first plurality of data records and wherein the second plurality of data records comprise data elements not found in the first plurality of data records.

16. The apparatus of claim 13, further comprising:
joining the first plurality of data records to a view from a master data database to clean and consolidate the first plurality of data records.

17. The apparatus of claim 13, wherein the method further comprises:
sending, via the processor, information associated with cleaning and consolidating the first plurality of data records, wherein the information associated with cleaning and consolidating the first plurality of data records is sent to the master data service.

18. The apparatus of claim 17, wherein the information comprises a selected dataset to be matched, a matching strategy, and a target database.
